(19) United States
(12) Patent Application Publication
(10) Pub. No.: US 2004/0205693 A1
(43) Pub. Date: Oct. 14, 2004

(54) Resource localization

(76) Inventors: Michael Alexander, Stittsville (CA); James F. Wimberley, Kanata (CA); Paul D. Wolff, Ottawa (CA); Robert Welbourn, Waban, MA (US)

Correspondence Address: FISH & RICHARDSON PC, 225 FRANKLIN ST, BOSTON, MA, 02110, US

(21) Appl. No.: 10/124,830

(22) Filed: Apr. 18, 2002

Related U.S. Application Data
(60) Provisional application No. 60/285,678, filed on Apr. 23, 2001.

(51) Int. Cl. G06F 9/44; G06F 9/00

(52) U.S. Cl. 717/100; 717/121; 718/104

(57) ABSTRACT

A method, apparatus and system for management of policy management servers across a geographically dispersed network is described. The policy management servers produce virtual points of presence (VPOP) for call service providers. The policy management servers are configured into clusters of policy management servers and during operation can distribute available ports for each VPOP among clusters of policy management servers.

This application claims the benefit of US Provisional Patent Application Serial No. 60/285,678 filed on Apr. 23, 2001 and entitled RESOURCE LOCALIZATION the entire contents of which are incorporated herein by reference.

### RESOURCE LOCALIZATION

### BACKGROUND

Policy management for Internet Service Providers relies on policy management servers being connected by a relatively high-speed, reliable network. In this environment, communication between servers has a reasonably low cost, and replies can be expected in a sufficiently short period of time and generally do not interfere with call processing. However, in geographically disperse applications, connections between policy management servers may be slow and/or unreliable. Communications take on a significantly higher performance cost, and it becomes unreasonable to wait for message replies while processing calls.

### SUMMARY

According to an aspect of the invention, a method of policy management for a call center includes configuring policy management servers into clusters of policy management servers and distributing available ports among clusters of policy management servers.

According to an additional aspect of the invention, an arrangement for policy management for a call center includes a plurality of policy management servers configured into clusters of policy management servers and a policy management server in each of the clusters of policy management servers to distribute available ports among the clusters of policy management servers.

According to an additional aspect of the invention, a computer program product residing on a computer readable medium comprises instructions for causing a processor to query configured clusters of policy management servers to locate available ports among the clusters of policy management servers in order to allocate additional ports to a server managed by the policy management server.

One or more aspects of the invention may provide one or more of the following advantages.

The invention provides the ability to separate policy management servers over geographical regions. Clusters of policy manager servers divide up the resources of a network into virtual points of presence (VPOPs) and associate these VPOPs with service providers. Each of these VPOPs is assigned a number of ports, which they are allowed to use at any given time. The technique distributes available ports for each VPOP among clusters of policy management servers. Each cluster will work with allotted ports, without having to communicate with other clusters on each call. When the number of a cluster's available ports for a given VPOP becomes low, one node within the cluster (the cluster master) will poll the other clusters, and steal additional ports from at least one of the other clusters, e.g., the cluster with the highest number available. Over time, the port allocations will drift into a state where the ports will be distributed by active use (i.e., geographical region with the highest density of users for a particular VPOP will have the highest number of ports for that VPOP). In addition, the clusters may be used to accommodate unusually high demand over short periods of time in a geographic region. Thus, resources will be localized to where they are most needed.

Aspects of the invention configure clusters of policy management servers to dynamically distribute ports of the policy management clustered servers. The policy management clustered servers solve the problems of geographically dispersed servers by allowing clusters of servers to perform general call processing independent of the other clusters, while sharing port usage information, as needed to enforce policies. Dynamically distributed ports avoids the problems of a central point of failure due to a central server and delays in call processing due to network traffic traveling over WANs, while increasing amounts of network traffic over large networks.

Aspects of the invention allow policy management across a geographically dispersed network of policy management clusters without the requirement of a centralized server. The globally managed resources will include portlimits/overflows and home gateway capacities.

In some embodiments the approach can dynamically distribute ports to provide redundancy between clusters. That is, should a cluster or a server within a cluster, become non-functional, other clusters can provide call processing for the non-functional cluster. Moreover, IP address pools can be shared within clusters or optionally between clusters. Also, in some embodiments session information can be shared between clusters. Small windows of time may exist that could allow temporary over subscription of concurrent session limits and home gateway capacities.

The details of one or more embodiments of the invention are set forth in the accompa- nying drawings and the description below. Other features, objects, and advantages of the invention will be apparent from the description and drawings, and from the claims.

### DESCRIPTION OF DRAWINGS

FIG. 1 shows a network layout.

FIGS. 2-4 are charts showing message sequences.

Like reference symbols in the various drawings indicate like elements.

### DETAILED DESCRIPTION

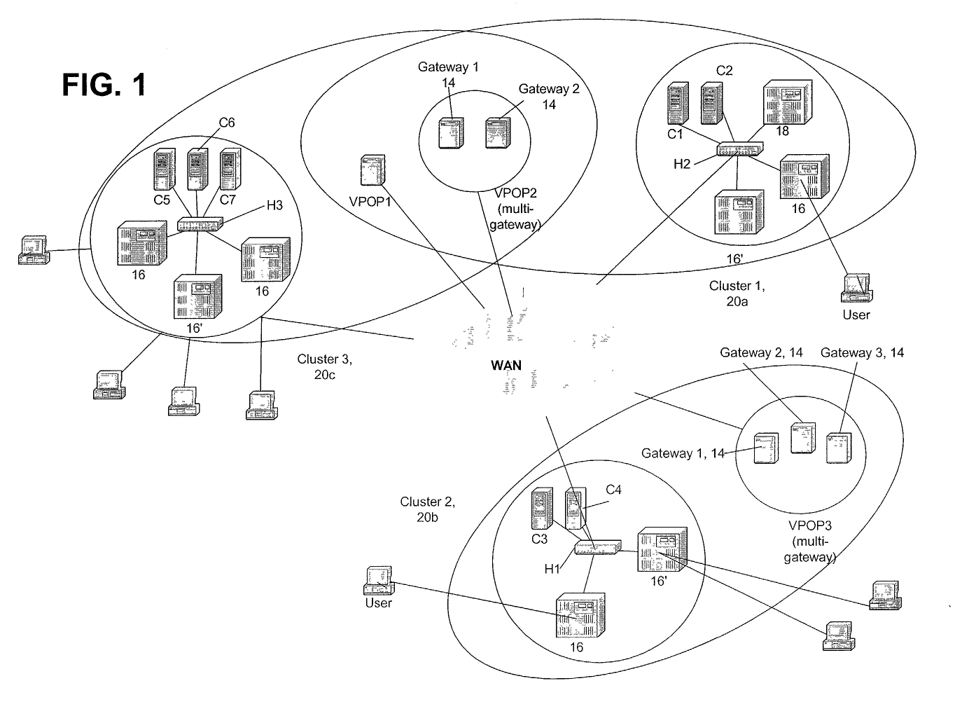

Referring to FIG. 1, a call access architecture 10 has an access switch (not shown) that delivers dial access, virtual private network (VPN), voice over IP (VoIP) and so forth. Gateways 12 are provided for call routing and processing, and facilitating delivery of services such as voice/fax over IP. The architecture 10 also includes call policy manager servers C1-C7. In one implementation the call policy manager servers C1-C7 include a software tool that provides a scalable architecture and robust functionality to monitor and manage a network of access switches while enforcing service policies on a network-wide basis. The call access architecture 10 executes a suite of network management browser-based applications that enable network managers to quickly and efficiently configure, manage, and troubleshoot network elements. These elements are arranged into clusters 20. Some elements, such as portlimits, overflows, and gateways may belong to multiple clusters, while others, such as network access switches (NAS), remote access switches (RAS) (generally 16), and call policy management servers C1-C7 may only belong to a single cluster 20. Other implementation s may allow any device to belong to any number of clusters. Such other implementations could incur an additional degree of difficulty in management of the clusters. The association of elements to clusters 20 is accomplished through the assignment of cluster numbers. Cluster members include call servers 18. A portlimit refers to the number of ports a given VPOP can use at any given time. The portlimit value can change depending on time of day, day of week, or day of year. An overflow is the number of ports a VPOP is allowed to use above the set portlimit at any given time. When a VPOP exceeds its assigned portlimit, a port will be assigned from the overflow. Accounting records will indicate this has occurred so the customer can be billed a premium for the use of the overflow. If the VPOP exceeds the portlimit+overflow, then calls will be rejected.

Each of the call policy management servers C1-C7 belongs to a single cluster 20. Thus call policy management servers C1-C2 belong to cluster 120a, call policy management servers C3-C4 belong to cluster 2 20b and call policy management servers C5-C7 belong to cluster 3 20c. Call policy management servers C1-C7 have a cluster number and call policy management servers C1-C7 with the same cluster number assigned to them belong to the same cluster 20. Call policy management servers C1-C7 interact with each other as redundant servers within a cluster 20. Thus call policy management servers C1-C2 interact in cluster 1 20a, call policy management servers C3-C4 interact in cluster 2 20b and call policy management servers C5-C7 interact in cluster 3 20c. Session information, IP address pools, concurrent session limits, and so forth are shared between those call policy management servers C1-C7 having the same cluster number. Call policy management servers C1-C7 with different assigned cluster numbers are in different clusters, and will only share information for the purposes of resource localization (i.e., exchanging free ports, exchanging gateway capacity).

Call policy management servers C1-C7 within the same cluster elect or can be assigned a cluster master policy server 18. This cluster master policy server 18 is the only policy management server permitted to exchange messages with servers C1-C7 outside the cluster 20. It is the responsibility of the cluster master 18 to monitor shared resources, and to proactively solicit other clusters 20 for available resources when its own resources are running low.

In a situation where local resources are completely exhausted, a call policy management server C1-C7 attempts to allocate resources for a call. One of the call policy manager servers C1-C7 contacts the appropriate cluster master policy server 18 and the cluster master policy server 18 contacts the other clusters 20 by sending a message requesting resources, e.g., need this resource now message. The other clusters 20 respond with the requested resource if available, and the cluster master relays that onto the original server C1-C7.

Portlimits may be associated with multiple clusters. They are managed by the cluster master 18 to ensure that the available resources are distributed among the clusters 20. Portlimits, are associated with other policy management servers C1-C7 across clusters 20 by their id numbers (i.e., cooperating portlimits have the same id number in all clusters 20 to which they belong).

During the initial configuration, portlimits and overflows are assigned a limit value. The assigned limit value is the total number of ports available in that portlim it across all associated clusters. Unless a cluster override element is configured (as discussed below), the minimum number of ports a cluster will maintain is zero; the maximum is the configured limit, and the initial is the configured limit divided by t he number of clusters to which the portlimit is associated.

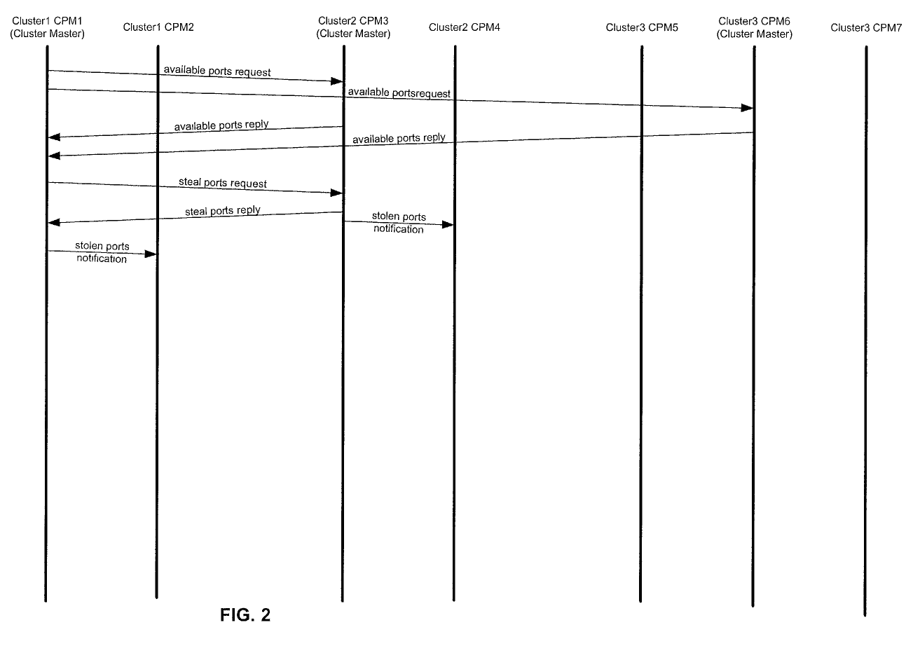

Referring to FIG. 2, when the number of available ports within the portlimit becomes low, the cluster master, (e.g., cluster 1 server C1) queries the other e.g., remote clusters (e.g., cluster 2 server C3 and cluster 3 server C6) for their number of available ports by sending an available ports request. The clusters 20 (e.g., cluster 2 server C3 and cluster 3 server C6) will respond with an available ports reply. The cluster master 18 (e.g., cluster 1 server C1) for the requesting cluster will issue a request steal ports request to reallocate ports from a remote cluster 20. Typically, the remote cluster (e.g., cluster 2 server C3) having the highest number of available ports will allocate ports to the requesting cluster master and respond with steal ports reply. These stolen or reallocated ports will be added to the number of available ports in the local cluster 20, and deducted from the available ports in the remote cluster 20 and all clusters will be updated with a stolen ports notification message.

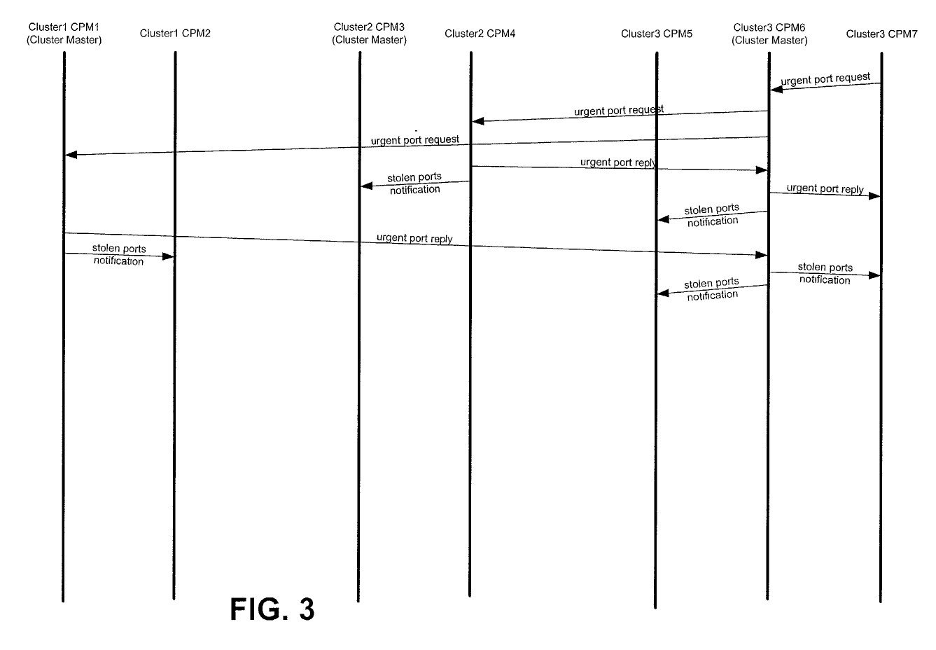

Referring to FIG. 3, when resources are low across all of the clusters 20, a server processing a call may not have any local ports available. The server (e.g., cluster 3 server C7) sends a request to the local cluster master (e.g., cluster 3 server C6) for an immediate port allocation urgent port request. The cluster master (cluster 3 server C6) forwards this urgent port request to all other clusters 20 (e.g., cluster 1 server C1 and cluster 2 server C3), along with a flag indicating whether overflow ports should be returned (if there are local overflow ports available, this flag will be set to false). The remote cluster masters (cluster 1 server C1 and cluster 2 server C3) respond with an urgent port reply message identifying a single port if available. This port is marked as an overflow port if applicable. The first non-overflow response received gets returned to the original server 18, and the identified port is assigned to the call. If no non-overflow responses are received, then the call is allocated from the overflow if available, otherwise it is rejected. The ports in the rest of the responses are treated as stolen ports via stolen port notifications.

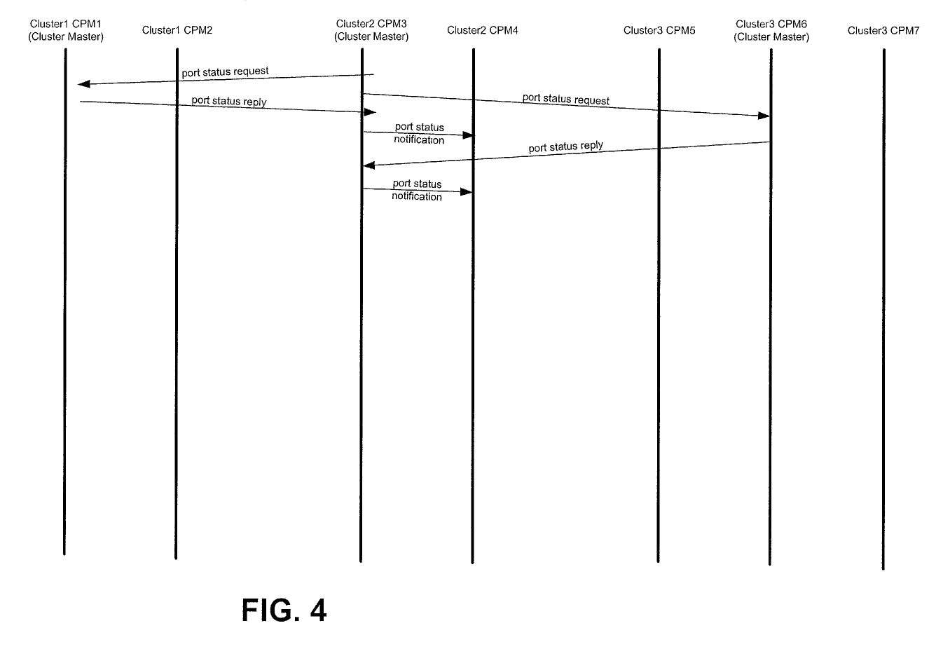

Referring to FIG. 4, as ports are stolen from one cluster 20 and given to another cluster 20, all of the clusters 20 are informed, so that each cluster 20 has a view of how the ports are currently distributed. If a single one of servers C1-C7 goes down, or loses communication, it will retrieve this information from another one of servers C1-C7 within its cluster 20 once it comes back online. If an entire cluster 20 is lost (e.g., cluster 2), then the cluster master 18 for that cluster 20 (e.g., cluster 2, server C3) will re trieve the current distribution of ports from the other clusters 20 (e.g., cluster 1, server C1 and cluster 3, server C6) once communication is reestablished. Once communication is restored, the cluster (e.g., cluster 2, server C3) will query the other clusters (e.g., cluster 1, server C1 and cluster 3, server C6) by port status messages to determine how many ports are actually available. Cluster 2, server C3 will receive port status notification messages from the other clusters (e.g., cluster 1, server C1 and cluster 3, server C6), and then attempt to borrow enough ports from the other clusters if required to cover the number of active sessions.

If a cluster is operating, but unable to contact the others, the cluster will assume that it has the configured maximum number of ports available to it.

It is possible to override the minimum, maximum and initial number of ports available within a cluster by configuring a cluster override within the portlimit. Overflows are handled in an identical manner to portlimits. In some embodiments, concurrent session limits are managed across clusters, while in other embodiments concurrent session limits are not managed across clusters.

Home gateways may be associated with multiple clusters, and the cluster masters will manage the capacity of the home gateways in the same manner as portlimits. Network access servers (NASs) may be assigned to a single cluster. Only the policy management servers within the same cluster as the NAS will perform audits on the NAS, or process calls from the NAS. If two sessions become active on the same gateway, but on different clusters, at the same time, then there is a small possibility that the gateway capacity may be exceeded regardless of the enforce capacity value.

A conventional policy manager divides up the resources of a network into virtual points of presence (VPOPs) and associates these VPOPs with service providers. Each of these VPOPs can be assigned a maximum number of ports, which they are allowed to use at any given time. When a call is processed by a policy management server, the policy management server allocates a port to the appropriate VPOP. The policy management server informs other policy management servers of the allocation so they are kept up to date. This conventional approach works when all of the policy management servers are in a single location, connected by a reliable, high-speed network. Thus, policy management relies on all policy management servers being connected by the relatively highspeed, reliable network. In this environment, communication between servers has a reasonably low cost, and replies can be expected in a sufficiently short period of time so as not to interfere with call processing.

The instant policy management server provides the ability to separate the policy management servers over geographical regions. In this environment, communications between the servers takes place over wide area networks (WANs), which are generally neither as fast, nor as reliable as LANS. With WANS it becomes unreasonable for all of the policy management servers to communicate on a per call basis in order to keep them all up to date.

The technique employs a method of distributing available ports for each VPOP among clusters 20 of policy management servers. Each cluster 20 will work with allotted ports, without having to communicate with the other clusters 20 on each call. When a cluster's 20 available ports for a given VPOP gets low, one policy manager server within the cluster 20 polls the other clusters 20, to have one of the other clusters allocate additional ports from that one cluster 20 with the highest number of available ports. Over time, the port allocations will drift into a state where the ports will be distributed by active use (i.e., geographical region with the highest density of users for a particular VPOP will have the highest number of ports for that VPOP). In addition, the clusters 20 may be used to accommodate unusually high demand over short periods of time in a geographic region. Thus, resources will be localized to where they are most needed.

This approach differs from a central server approach to which all of the other servers communicate. A central server approach requires network traffic to travel through a WAN during call processing, which could cause delays. It also creates a single point of failure, should that central server, or the links to it, fail.

Clusters of policy management servers are configured to dynamically distribute ports of the policy management clustered servers. The policy management clustered servers aim to solve problems of geographically dispersed servers by allowing clusters 20 of servers to perform general call processing independent of the other clusters 20, while sharing port usage information, as needed to enforce policies. Dynamically distributed ports also avoids problems of a central point of failure due to a central server and delays in call processing due to network traffic traveling over WANs, while increasing amounts of network traffic over large networks.

The approach dynamically distributes ports to provide redundancy between clusters. That is, should a cluster 20 or a server within a cluster 20, become non-functional, other clusters 20 can provide call processing abilities for the non-functional cluster 20. Moreover, IP address pools can be shared within clusters 20 or optionally between clusters 20. Also, session information can be shared between clusters 20. Small periods of use can exist which will allow temporary over subscription of concurrent session limits and home gateway capacities.

The following is an exemplary command line interface to the above arrangement:

config server

set defaultCluster <clusterNumber>

config pmServer <id>

set cluster <clusterNumber>

config nas <id>

set cluster <clusterNumber>

config gateway <id>

add cluster <clusterNumber>
remove cluster <clusterNumber>
show clusters

config portlimit <id>

add cluster <clusterNumber>
remove cluster <clusterNumber>
show clusters config limit <id>

set limit <limit>
show clusterOverride [id]
config clusterOverride <id>

set cluster <clusterNumber>
set intialLimit <limit>
set minLimit <limit>
set maxLimit <limit>

config overflow <id>

add cluster <clusterNumber>
remove cluster <clusterNumber>
config limit <id>

set limit <limit>
show clusterOverride [id]
config clusterOverride <id>

set cluster <clusterNumber>
set initialLimit <limit>
set minLimit <limit>
set maxLimit <limit>

change cluster <oldClusterNumber> <newClusterNumber>

The set defaultCluster command sets the cluster number for all elements that have not been specifically given a cluster number. The default value is 1. The set cluster command sets which cluster the current element belongs to.

The add cluster command adds a cluster to the set of clusters to which an element belongs. The remove cluster command removes a cluster from the set of clusters to which an element belongs.

The show cluster command shows all of the clusters to which an element belongs. The change cluster command moves all elements within the cluster specified by oldClusterNumber to the cluster specified by newClusterNumber.

The config limit command can be changed to set the initial number of ports assigned to the portlimit. This limit is distributed among all of the clusters for which there is no specified override.

The show clusterOverride shows one or all of the configured cluster overrides. The config clusterOverride configure s a new or existing cluster override element.

The set initialLimit command sets the initial number of ports this portlimit/overflow will maintain within the associated cluster. The config minLimit command sets the minimum number of ports this portlimit/overflow will maintain within the associated cluster. The config maxLimit command sets the maximum number of ports this portlimit/overflow will maintain within the associated cluster.

Other embodiments are within the scope of the appended claims.

What is claimed is:

1. A method of policy management for a call center, the method comprising:
configuring policy management servers into clusters of policy management servers; and
distributing available ports among clusters of policy management servers.

2. The method of claim 1 wherein each cluster of policy management servers works with allotted ports from at least one other of the clusters of policy management servers.

3. The method of claim 1 wherein each cluster of policy management servers processing calls works with allotted ports from at least one other of the clusters of policy management servers without communicating with the other clusters on each call.

4. The method of claim 1 wherein as a cluster's available ports becomes low, a policy management server in the cluster polls the other clusters to have the other clusters allocate additional ports from a remote cluster having available ports.

5. The method of claim 1 wherein as a cluster's available ports for a given VPOP becomes low, a policy management server in the cluster polls the other clusters to steal additional ports from a remote cluster having the highest number of available ports.

6. The method of claim 1 wherein globally managed resources across clusters of policy management servers include portlimits/overflows and home gateway capacities.

7. The method of claim 1 further comprising:
assigning each VPOP with a maximum number of ports.

8. The method of claim 1 wherein distributing further comprises:
communicating with policy management servers across a geographically dispersed network of policy management servers, which produce virtual points of presence (VPOP) for call service provider.

9. The method of claim 1 wherein distributing further comprises:
communicating with policy management servers across a geographically dispersed network of policy management servers by sending messages that request port status to the other clusters, and receiving reply messages indicating the status of ports on the clusters.

10. An arrangement for policy management for a call center comprising:
a plurality of policy management servers configured into clusters of policy management servers; and
a policy management server in each of the clusters of policy management servers to distribute available ports among the clusters of policy management servers.

11. The arrangement of claim 10 wherein each cluster of policy management servers works with allotted ports from at least one other of the clusters of policy management servers.

12. The arrangement of claim 10 wherein each cluster of policy management servers that processes calls works with allotted ports from at least one other of the clusters of policy management servers without communicating with the other clusters on the processed calls.

13. The arrangement of claim 10 further comprising:
a policy management server in each cluster that polls the other clusters to have the other clusters allocate additional ports from a remote cluster having available ports to a server in the cluster as the servers available ports becomes low.

14. The arrangement of claim 13 wherein the policy management server in the cluster that polls the other clusters, steals additional ports from a remote cluster having the highest number of available ports.

15. The arrangement of claim 10 wherein globally managed resources across clusters of policy management servers include portlimits/overflows and gateway.

16. The arrangement of claim 10 wherein master policy management servers communicate with other master policy management servers across a geographically dispersed network.

17. A policy management server comprising:
a machine; and
a computer readable medium storing a computer program product for causing the machine to query configured clusters of policy management servers to locate available ports among the clusters of policy management servers in order to allocate additional ports to a server managed by the policy management server.

18. The policy management server of claim 17 wherein the instructions further comprise instructions to cause the policy management server polls the other clusters to have the other clusters allocate additional ports from a remote cluster having the highest number of available ports to the server in the cluster.

19. A computer program product residing on a computer readable medium comprises instructions for causing a processor to:
query configured clusters of policy management servers to locate available ports among the clusters of policy management servers in order to allocate additional ports to a server managed by the policy management server.

20. The computer program product of claim 19 wherein the instructions further comprise instructions to:
poll other clusters to have the other clusters allocate additional ports from a remote cluster having the highest number of available ports to the server in the cluster.
